(19) United States
(12) Patent Application Publication
(10) Pub. No.: US 2013/0055095 A1
(43) Pub. Date: Feb. 28, 2013

(54) RESEARCH SYSTEMS AND METHODS FOR RESEARCHING AT LEAST ONE TOPIC

(71) Applicant: Sarah Clark Kavanagh, Chevy Chase, MD (US)

(72) Inventor: Sarah Clark Kavanagh, Chevy Chase, MD (US)

(21) Appl. No.: 13/589,803

(22) Filed: Aug. 20, 2012

Related U.S. Application Data
(60) Provisional application No. 61/526,197, filed on Aug. 22, 2011.

(51) Int. Cl. G06F 15/173; G06F 3/01

(52) U.S. Cl. 715/738; 709/226

(57) ABSTRACT

A computer-based method for use in researching at least one topic using a computing device coupled to a memory device is provided. The method includes receiving, at the computing device, from a user a selection of at least one of a client and a client matter, querying the memory device to determine a research strategy associated with the at least one of a client and a client matter in response to the selection, and providing, at the computing device, for presentation to the user the research strategy associated with the at least one of a client and a client matter, wherein the research strategy includes at least one resource and at least one resource designator associated with the at least one resource.

### CROSS-REFERENCE TO RELATED APPLICATIONS

This application claims priority to U.S. Provisional Application No. 61/526,197 filed Aug. 22, 2011, the entire disclosure of which is hereby incorporated by reference in its entirety.

### FIELD

The present disclosure relates generally to research systems and methods for researching at least one topic.

### BACKGROUND

This section provides background information related to the present disclosure which is not necessarily prior art.

Research may be performed through use of one or more resources, including, without limitation, books, periodicals, online databases, web search engines, etc. In general, the topic selected for research indicates one or more types of resources particularly suited for the research. For example, legal research is known to involve the review of court decisions through use of case reporters, treatises, and/or online legal research, such as the Westlaw® research website and the LexisNexis® research website. Each resource for the various types of research is selected independent of other resources and separately utilized by a researcher. Accordingly, an administrator may be required to manage numerous resources, including subscriptions, credentials, usage data, etc.

Moreover, certain clients may require that certain resources be used before other resources, or may limit or totally restrict approval for one or more resources. Administrators are tasked with the control of resources, on a client by client basis, as well as in the context of the law firm's policies and/or resource contracts.

### SUMMARY

This section provides a general summary of the disclosure, and is not a comprehensive disclosure of its full scope or all of its features.

According to one aspect of the present disclosure, a computer-based method for use in researching at least one topic using a computing device coupled to a memory device is provided. The method includes receiving, at the computing device, from a user a selection of at least one of a client and a client matter, querying the memory device to determine a research strategy associated with the at least one of a client and a client matter in response to the selection, and providing, at the computing device, for presentation to the user the research strategy associated with the at least one of a client and a client matter, wherein the research strategy includes at least one resource and at least one resource designator associated with the at least one resource.

According to another aspect of the present disclosure, a computer-based method for use in researching at least one topic is provided. The method includes receiving, at a computing device, a request to add a resource, the request including a web address for the resource, automatically generating, at the computing device, a resource entry for the resource, the resource entry configured to launch a web browser directed to the web address within a resource connector, when the resource entry is selected by a user; and providing a user interface including the resource entry for presentation to the user.

According to yet another aspect of the present disclosure, a computing device for use in researching at least one topic is provided. The computing device includes an input device configured to receive from a user a selection of at least one of a client and a client matter, a processing device coupled to the input device and configured to determine a research strategy associated with the at least one of a client and a client matter in response to the selection, and a display device coupled to the input device and configured to present to the user the research strategy associated with the at least one of a client and a client matter, wherein the research strategy includes at least one resource and at least one resource designator associated with the at least one resource.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a block diagram of an exemplary computing device.

FIG. 2 is a block diagram of a research system according to one embodiment of the present disclosure.

FIG. 3 is an exemplary dashboard user interface for an administrator that may be used with the research system shown in FIG. 2.

FIG. 4 is an exemplary resource interface with a manage resource tab selected that may be used with the research system shown in FIG. 2.

FIG. 5 is the exemplary resource interface of FIG. 4 with a create resource tab selected that may be used with the research system shown in FIG. 2.

FIG. 6 is an exemplary resource edit interface that may be used with the research system shown in FIG. 2.

FIG. 7 is an exemplary research strategy interface with a manage research strategy tab selected that may be used with the research system shown in FIG. 2.

FIG. 8 is the exemplary research strategy interface of FIG. 7 with a create research strategy tab selected that may be used with the research system shown in FIG. 2.

FIG. 9 is an exemplary research strategy edit interface that may be used with the research system shown in FIG. 2.

FIG. 10 is an exemplary client matter setup interface with a create client matter tab selected that may be used with the research system shown in FIG. 2.

FIG. 11 is the exemplary client matter setup interface of FIG. 10 with an upload client matter tab selected that may be used with the research system shown in FIG. 2.

FIG. 12 is an exemplary client setup interface with a create client tab selected that may be used with the research system shown in FIG. 2.

FIG. 13 is an exemplary system setting setup interface with a practice group tab selected that may be used with the research system shown in FIG. 2.

FIG. 14 is the exemplary system setting setup interface of FIG. 13 with a job title tab selected that may be used with the research system shown in FIG. 2.

FIG. 15 is the exemplary system setting setup interface of FIG. 13 with a researcher dashboard default type tab selected that may be used with the research system shown in FIG. 2.

FIG. 16 is an exemplary global alert interface with a create global alert tab selected that may be used with the research system shown in FIG. 2.

FIG. 17 is the exemplary global alert interface of FIG. 16 with an alert history tab selected that may be used with the research system shown in FIG. 2.

FIG. 18 is an exemplary dashboard interface for a researcher that may be used with the research system shown in FIG. 2.

FIG. 19 is an exemplary select resource interface for a selected client matter that may be used with the research system shown in FIG. 2.

FIG. 20 is an exemplary research connector overlaid on a web browser directed to a resource that may be used with the research system shown in FIG. 2.

FIG. 20 is the exemplary connector of FIG. 4 with a research connector add note interface that may be used with the research system shown in FIG. 2.

FIG. 21 is an exemplary add note interface that may be used with the research system shown in FIG. 2.

FIG. 22 is an exemplary add note interface that may be used with the research system shown in FIG. 2.

FIG. 23 is an exemplary add comment interface that may be used with the research system shown in FIG. 2.

FIG. 24 is an exemplary rating interface that may be used with the research system shown in FIG. 2.

### DETAILED DESCRIPTION

The embodiments described herein relate to researching at least one topic through use of a research application. More specifically, in some embodiments, the research application is hosted by a research server or another server to provide user interfaces to a researcher, an administrator, or other user to facilitate research of the at least one topic.

Exemplary technical effects of the methods and systems described herein may include at least one of (a) receiving from a user a selection of a research matter, (b) querying a memory device to determine a research strategy associated with the research matter, and (b) providing for presentation to the user a research strategy associated with the research matter in response to the selection. The research strategy includes at least one resource and at least one resource designator associated with the at least one resource. Additionally, or alternatively, exemplary technical effects of the methods and systems described herein may include at least one of (a) receiving a request to add a resource, (b) automatically generating a resource entry for the resource, and (c) providing a user interface for presentation to a user. The request includes a web address for the resource. The resource entry is configured to launch a web browser directed to the web address within a resource connector, when the resource entry is selected by a user. The user interface includes the resource entry.

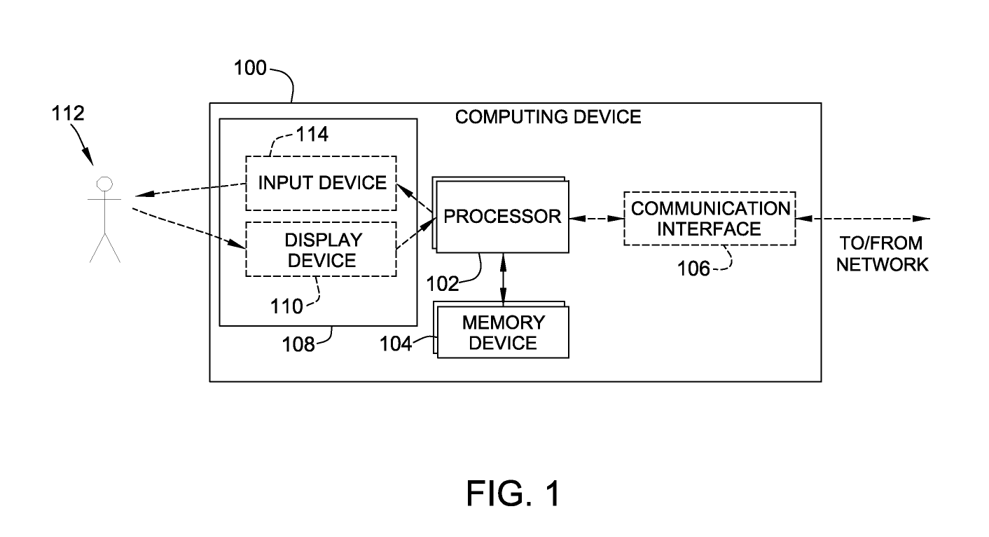

FIG. 1 illustrates an exemplary computing device 100. In the exemplary embodiment, computing device 100 includes a memory device 104 and a processor 102 coupled to memory device 104. In some embodiments, executable instructions are stored in memory device 104 and executed by processor 102. Computing device 100 is configurable to perform one or more operations described herein by programming and/or configuring processor 102. For example, processor 102 may be programmed by encoding an operation as one or more executable instructions and providing the executable instructions in memory device 104.

Memory device 104 is one or more devices operable to enable information such as executable instructions and/or other data to be stored and/or retrieved. Memory device 104 may include one or more computer readable media, such as, without limitation, hard disk storage, optical drive/disk storage, removable disk storage, flash memory, non-volatile memory, ROM, EEPROM, random access memory (RAM), etc. Memory device 104 may be configured to store, without limitation, computer-executable instructions, transmitter identifiers, account identifiers, payment account information, and/or any other type of data. Memory device 104 may be incorporated in and/or separate from processor 102.

Processor 102 may include one or more processing units (e.g., in a multi-core configuration). The term processor, as used herein, refers to central processing units, microprocessors, microcontrollers, reduced instruction set circuits (RISC), application specific integrated circuits (ASIC), logic circuits, and any other circuit or processor capable of executing instructions to perform functions described herein.

Computing device 100 includes a communication interface 106 coupled to processor 102. Communication interface 106 is configured to be coupled in communication with one or more other devices, such as another computing device 100, a network, etc. Communication interface 106 may include, without limitation, a serial communication adapter, a wired network adapter, a wireless network adapter, a mobile telecommunications adapter, a radio frequency (RF) receiver, a radio frequency identification (RFID) reader, and/or any other device capable of communicating with one or more other devices. Communication interface 106 may transmit information to and/or receive information from one or more other computing devices 100.

In this exemplary embodiment, computing device 100 includes a user interface 108 to interact with user 112, such as an administrator or a researcher. As illustrated, user interface 108 includes a display device 110, Display device 110 may include, for example, a cathode ray tube (CRT), a liquid crystal display (LCD), an LED display, an organic LED (OLED) display, an “electronic ink” display, and/or other device suitable to display information. Additionally, or alternatively, user interface 108 may include an audio output device (e.g., an audio adapter, a speaker, etc.).

User interface 108 may include an input device 114 to receive one or more inputs from user 112. Input device 114 may include, without limitation, a button, a knob, a keypad, a pointing device, a mouse, a touch sensitive panel (e.g., a touch pad or a touchscreen), a gyroscope, a position detector, and/or an audio input (e.g., a microphone). In various embodiments, user interface 108 may include a single component, such as a touchscreen display, incorporating both display device 110 and input device 114.

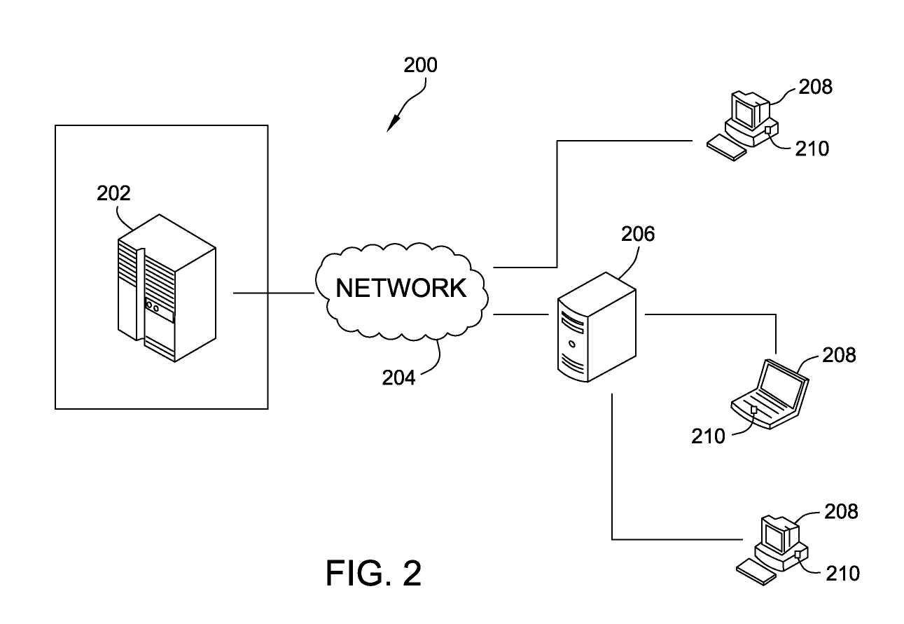

FIG. 2 illustrates an exemplary research system 200 for use in researching at least one topic. Research system 200 includes a research server 202 coupled to a network 204. Network 204 may include, without limitation, the Internet, an intranet, a local area network (LAN), a cellular network, a mobile network, and/or a wide area network (WAN), etc. Research system 200 may be employed to perform various types of research, including, without limitation, legal research, business research, medical research, financial research, and/or news research, etc. In the exemplary embodiment, research system 200 includes a client server 206 on the premises of an entity and multiple client workstations 208 associated with the entity, either on the premises of the entity or remotely situated, while being accessible to a user associated with the entity. In the exemplary embodiment, the entity is described as a law firm, employing the research application to perform legal research. It should be appreciated that other entities, such as companies, firms, association, corporations, etc., may employ the research applications described herein to perform a variety of different types of research.

Workstations 208 may be connected to network 204, directly or indirectly through client server 206, as illustrated in FIG. 2. Workstations 208 may include, without limitation, a computer, a laptop, a desktop, a personal digital assistant (PDA), a smartphone, or other device suitable to perform as described herein. As should be apparent, client servers and/or workstations may be situated elsewhere in other research system embodiments.

It should be appreciated that research server 202, client server 206 and workstations 208 are examples of computing devices 100.

Research server 202 is configured to provide a research application, including multiple user interfaces, for use by a user at workstation 208. In this exemplary embodiment, the research application is substantially hosted by research server 202. It should be appreciated that the research application may be hosted at research server 202, client server 206 and/or workstation 208 in other research system embodiments. More specifically, the research application may be include any suitable application hosted and/or executed from one or more of research server 202, client server 206, and workstation 208. In one example, research application is hosted and executed on workstation 208, such that network 204 and/or servers 202 and 206 may be omitted. In such examples, client server 206 and/or workstation 208 are configured appropriately to host and/or execute various functions associated with the research application, as described herein. Such configuration may include meeting certain software requirements, such that computing devices 100 includes a LAMP package (Linux, Apache, MySQL, PHP) along with JDK(Java Development Kit)

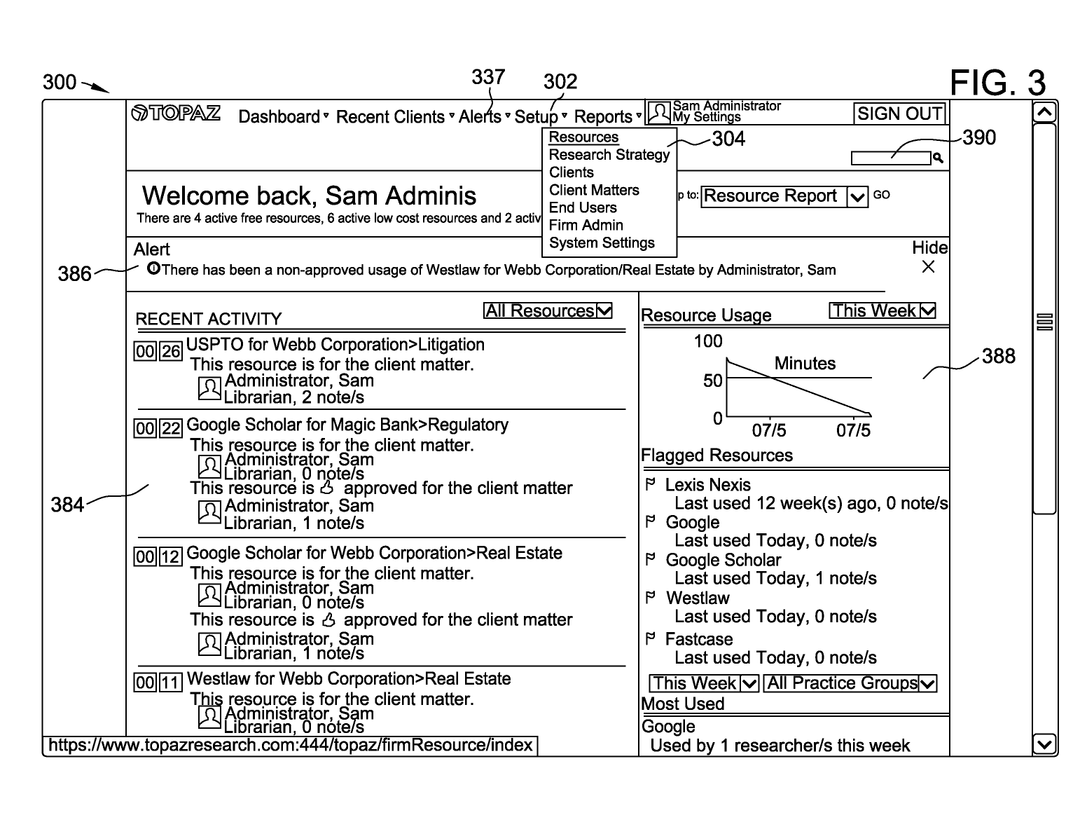

FIGS. 3-24 illustrate multiple user interfaces of the exemplary research application. Each of the interfaces is provided from research server 202 for presentation to the user 112 at one or more workstations 208. In the exemplary embodiment, the research application includes a research website accessible at workstations 208 by a web browser, such as Internet Explorer, Firefox, Google Chrome, Safari, etc. The research website includes multiple user interfaces, which include web pages. It should be appreciated, however, that the research applications described herein may include various types of applications and/or programs, and thus are not limited to websites and/or web pages provided by research server 202 for presentation to the user 112 at workstation 208. For example, the research application may include an application executed by client server 206 and/or workstation 208 local to the law firm, such that websites and/or web pages may be omitted. Further, in several embodiments, the research application may be divided among research server 202, client server 206 and/or 208, such that any portion of the interfaces of the research application, including none, are provided through network 204.

In this exemplary embodiment, each workstation 208 includes a research connector 210. Research connector 210 is configured to interact with the research application to host and/or overlay one or more web browsers, as described herein. It should be appreciated that research connector 210 may be integrated with research application and/or omitted in other research system embodiments.

The research application includes numerous user interfaces provided from research server 202 for presentation at workstation 208. The number and type of user interfaces accessible by a user of workstation 208 may be based on the type of research to be performed and/or the type of user accessing the research application. In the exemplary embodiment, user 112 may include an administrator (e.g., a librarian, IT professional), a researcher (e.g., an attorney, paralegal, reporter, financial analyst), or other individual involved in management and/or use of research resources. In one example, an administrator may have access to a variety of user interfaces to affect various setup, control, alert, and/or reporting options, while a researcher's access may be limited to user interfaces associated with performing research. In various embodiments, research server 202 may receive a credential from the user 112, prior to permitting access to one or more user interfaces. In at least one embodiment, the credential presented by a user 112 (e.g., a username and a password) and received by research server 202 may automatically designate the user 112 as an administrator, researcher, or other type of user.

Upon accessing the research application, research server 202 provides a dashboard interface for presentation to the user 112 at workstation 208. One exemplary dashboard interface 300 for an administrator user 112 is illustrated in FIG. 3. Dashboard interface 300 includes a setup button 302, which is provided to access a setup menu 304. As shown, setup menu 304 provides multiple options for display to the administrator user 112 related to resources, resource strategies, clients, client matters, end users, firm administration, and system settings. As should be apparent, the setup options may be different in other research application embodiments, potentially providing more or less setup options to the administrator user 112.

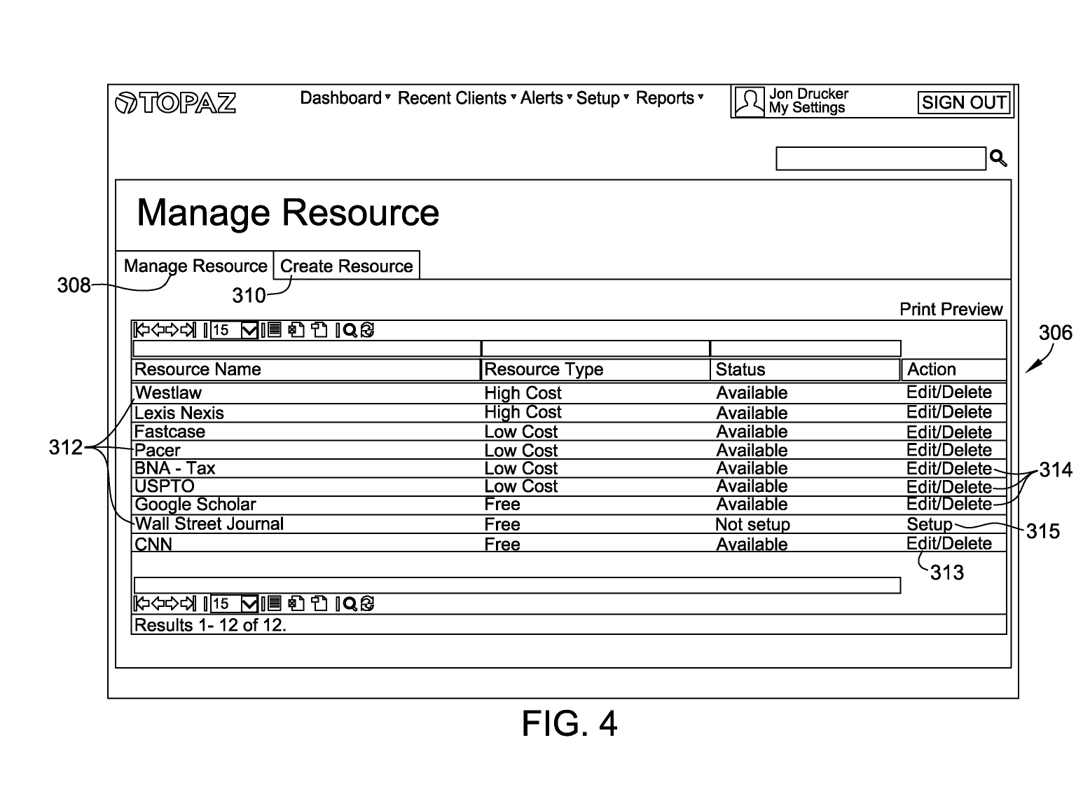

In this exemplary embodiment, when the administrator user 112 selects the resource setup option from setup menu 304, research server 202 provides an exemplary resource interface 306 (FIG. 4). Resource interface 306 provides two tabs: manage resource tab 308 and create resource tab 310. As shown, under manage resource tab 308, resources interface 306 includes a listing of the resource entries within the research application. Specifically, as shown, the example resources include, without limitation, Westlaw® research website, LexisNexis® research website, Google Scholar, PACER, BNA-Tax, United States Patent and Trademark Office (USPTO), CNN, Wall Street Journal, etc. It should be appreciated that one or more other resources may be included, added, and/or deleted from the list of resources in other embodiments. More specifically, for example, research applications according to the present disclosure may include any number and/or type of resource suitable to perform any type of research about at least one topic. Resource may be selected, for example, potentially based on the content of the resource, cost associated with the resource, and/or the accessibility of the resource via network 204.

The listing of resources permits administrator user 112 to view the existing resource entries 312, search existing resource entries 312, and/or edit/setup/delete one or more of existing resource entries 312. In this exemplary embodiment, the user may select create resource tab 310 to add a resource entry to the research application for presentation to the user at workstation 208.

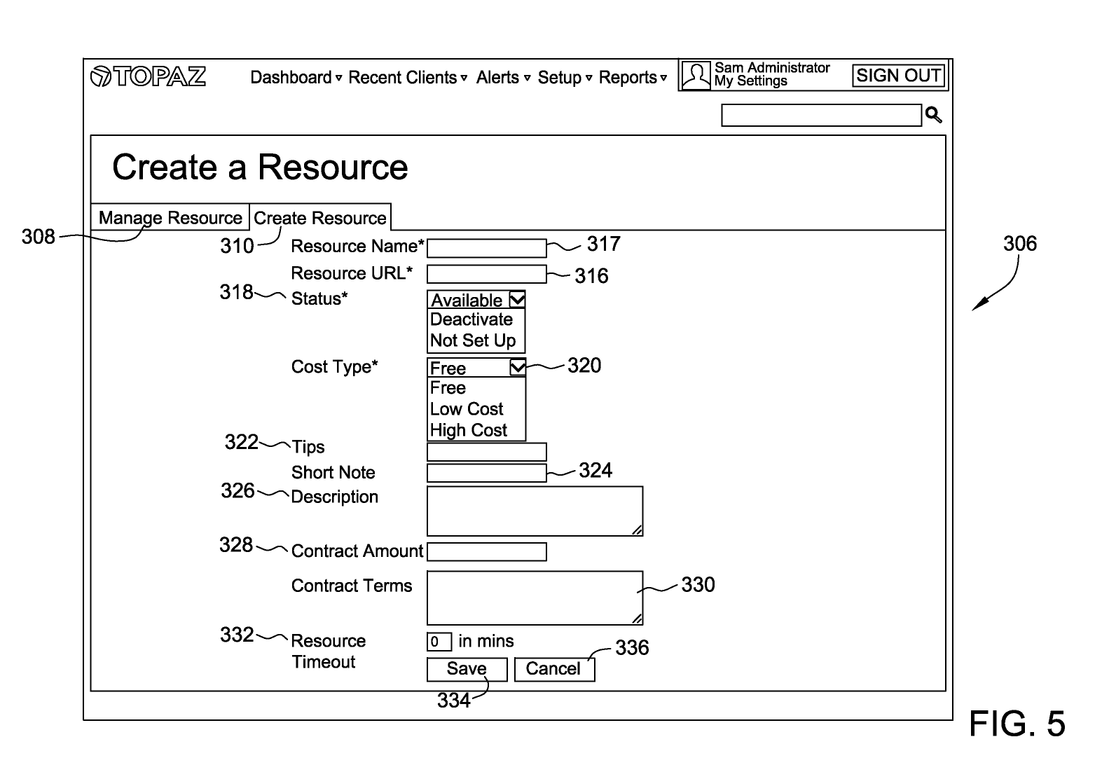

Resource interface 306 is illustrated in FIG. 5, with create resource tab 310 selected. Create resources tab 310 includes several fields for the user to enter information related to the resource, which is usable to add a resource to the research application. More specifically, the resource may be added to the research application by providing some or all of the information requested in create resource tab 310 and submitting such information to research server 202. It should be appreciated that various types of information and/or designators may be solicited by the create resource tab 310 in other embodiments. Specifically, for example, as illustrated in FIG. 5, create resource tab 310 solicits a resource name 317, resource uniform resource locator (URL) 316 (e.g., a web address), a status 318, a cost type 320, tips 322, short notes 324, a description 326, a contract amount 328, contract terms 330, and a resource timeout 332. As shown, status 318 permits administrator user 112 to select available, deactivate, or not setup from the pull down menu, while cost type 320 of the resource generally indicates a cost associated with the resource. For example, as shown, cost type 320 may be selected from a pull down menu, including free, low cost, or high cost. Additional or alternative cost types indicative of relative cost may be included in other resource interface embodiments. In some example, the cost type may be more specific, potentially even indicating a price range per search and/or access of the resource. Tips 322 may include, for example, one or more messages created by administrator user 112 as to how to efficiently use the resource. Further, tips 322 may be employed to advise user 112 of specific features offered by a resource, suggest shortcuts, warn when not to use the specified resource, and provide alternatives to the resource. In the exemplary embodiment, short note 324 may include notes regarding the service/resource for internal use. Description 326 provides a description of the resource, a source of the resource, and/or content of the resource, etc.

In the exemplary embodiment, contract amount 328 may include a contract amount for accessing the resource, such as total contract amount, cost per search performed, cost per interval of time, cost per request, etc. The contract terms 330 may include various aspects about a contract formed with the resource provider, such as subscription details, cost charges per function performed on the resource, etc. The resource timeout 332 may include a timeout interval, at which time a dialog box appears warning researcher user 112 that there has been no activity and indicate disconnection from the resource is imminent unless they click “OK”. If the researcher fails to respond to the dialog box, the resource automatically times out. More specifically, for a resource having a cost based on a unit of time, the research application may automatically time out a research session for the resource, after the timeout interval runs without activity. The timeout interval may include, for example, about 1 minute, about 5 minutes, about 15 minutes, about 30 minutes, about an hour, a 3 hour interval, or another suitable interval.

Further, as shown in FIG. 5, some of the information solicited has an asterisk next to the field name, designating such information as the minimum information necessary to submit the resource to be added to the research application. As should be apparent, different information may be solicited and/or other information may be indicated as required in other embodiments. In at least one embodiment, one or more requirement for specific information may be omitted.

Furthermore, in some embodiments, resource interface 306 may solicit credential information for the resource. More specifically, a resource may require one or more credentials to access content of the resource. In such embodiments, resource interface 306 may solicit one or more credentials, which may then be auto-filled and/or automatically submitted to the resource by the research application. In another embodiment, credentials may be provided to be displayed to user 112 when initiating a research session involving the respective resource. In other embodiments, credentials for one or more resources may be solicited at a different time or not at all by the resource application.

Once information, including the required information (if any) is entered, the user 112 may select the “save” button 334 at workstation 208 to submit the add resource request to the research server 202. Conversely, the user may selected a “cancel” button 336 to not submit the add resource request to the research server 202.

In this exemplary embodiment, when the add resource request is submitted, research server 202 receives the request to add the resource to the research application. The add resource request is stored in memory device 104 of research server 202. In this exemplary embodiment, research server 202 automatically generates a resource entry 312 for the resource. The resource entry is configured to launch a web browser directed to the web address within research connector 210 of workstation 208, when the resource entry is selected by user 112, as described below. The resource entry is configured to launch a web browser to host the resource in order to utilize one or more common functions of the web browser, such as browser navigation, print and right-click functionality.

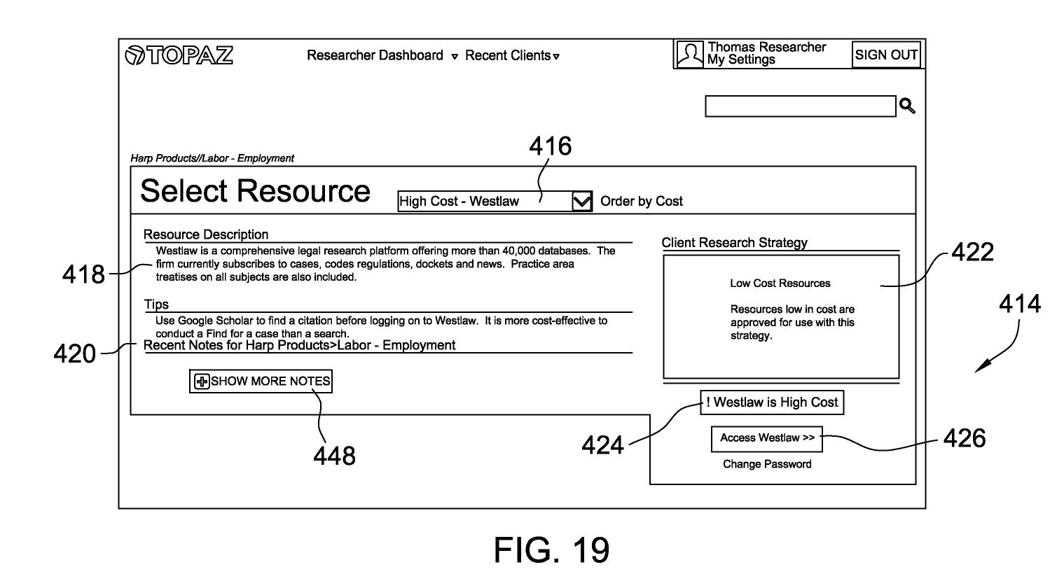

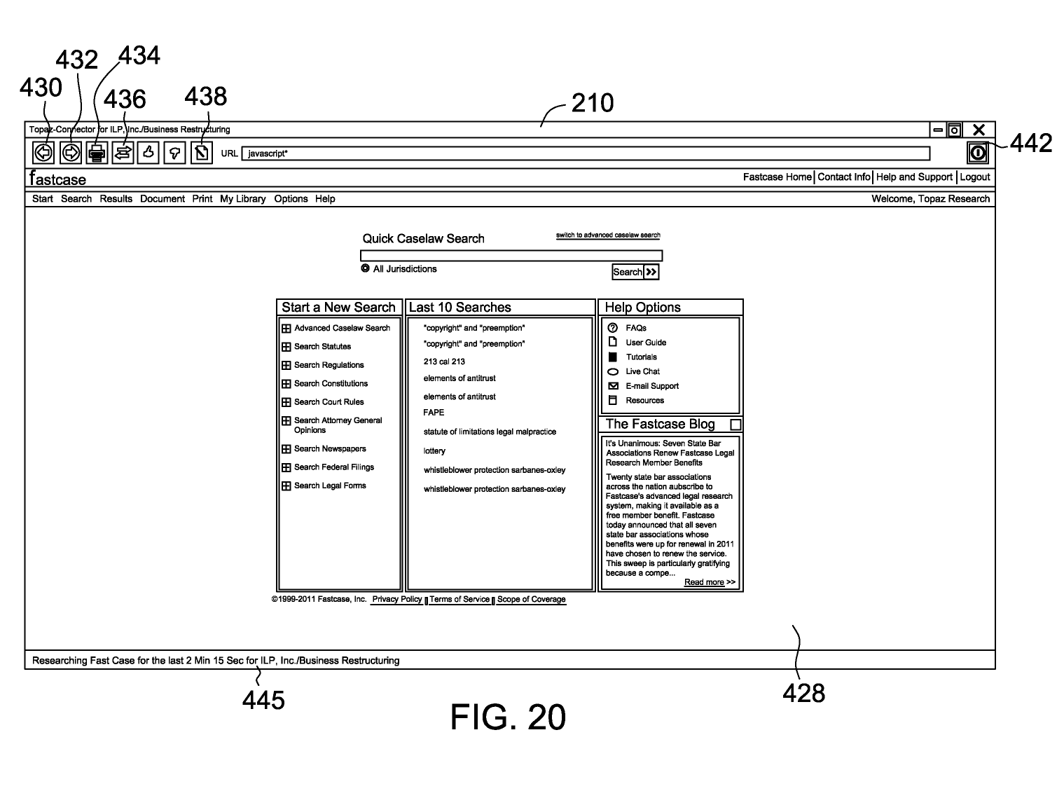

Additionally, or alternatively, when the resource requires one or more credentials in order to access content of the resource, research server 202 may auto-fill one or more credentials to provide direct access to the resource through a web browser launch within research connector 210. More specifically, when credentials are required, research server 202 provides researcher user 112 an opportunity to enter credentials when a new resource is initially accessed. If resource credentials are entered by researcher user 112, the credentials are stored in a database function of research connector 210 and associated with the particular resource. Research connector 210 automatically retrieves the credentials and provides the credentials to the resource when the resource is chosen in subsequent research sessions. In the example embodiment, research connector 210 is configured to store multiple credentials for multiple different resources. In this manner, the research application and/or research server 202 provides credential (e.g., username and password) management for the user 112, such that the user 112 is not required to repeatedly manage and enter credentials for different resources, as compared to known resource websites. The launch of the web browser is described in further detail below with reference to FIGS. 19-20.

Once the research entry is generated, research server 202 provides the resource entry for presentation to the user. For example, as shown in FIG. 4, resource entries 312 are displayed to administrator user 112 through workstation 208 in manage resource tab 308.

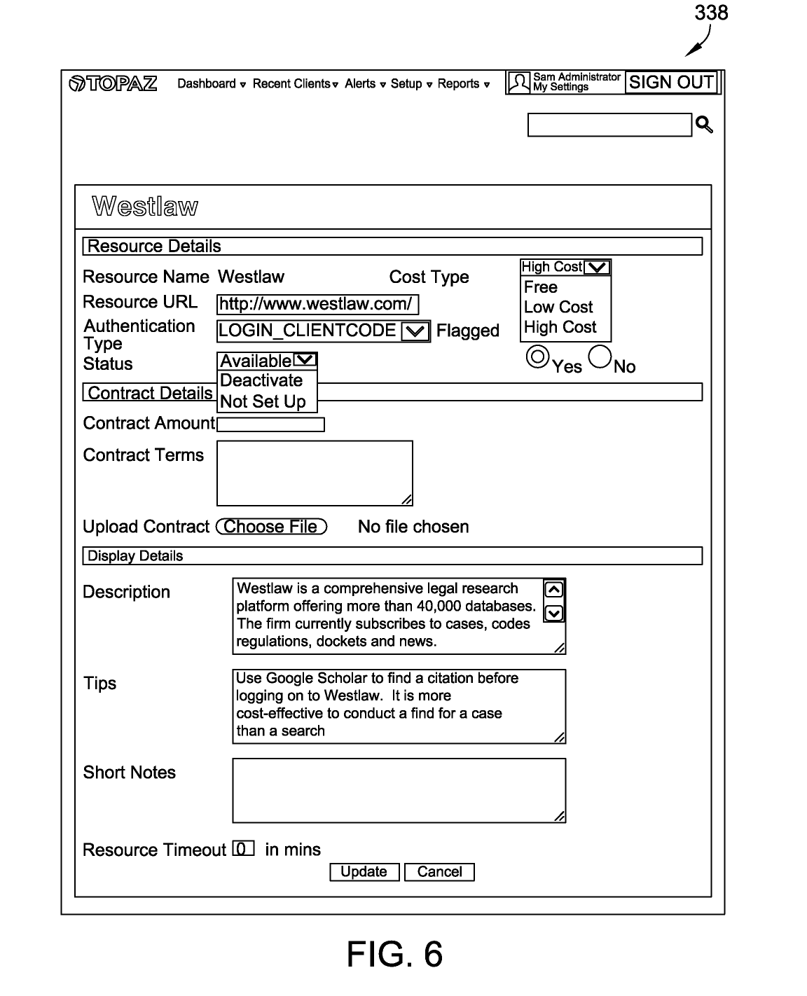

Further, resource entries 312 may be edited and/or deleted from the research application. Specifically, in this exemplary embodiment, administrator user 112 may edit the resource entry by selecting an “edit” button 313 associates with one of more of the resource entries. When the “edit” button 313 or the “setup” button 315 is selected, edit resource interface 338 (FIG. 6) is provided from research server 202 for presentation to the user 112 at workstation 208. As shown, one or more of the fields present in create resource tab 310 are editable in the edit resource interface 338. In the exemplary embodiment, through the creation and/or editing of the resource, the research application provides the ability to communicate one or more client research strategies to direct researcher user 112 regarding specific projects or types of research at workstation 208 which is where and when the research is performed. In this manner, research application provides a single application for managing resources, cost associated with resources, and control of the resources, while providing utilization data of any and/or all of the resources accessed through the research application. Accordingly, the research application provides a centralized control for resources. In contrast, known research method techniques involve simply cutting off access to specific resources, which often negatively affects productivity and morale of users. Referring again to FIG. 4, administrator user 112 is further permitted to delete one of existing resource entries 312, by providing an input to a “delete” button 314 associated with one or more of the resources.

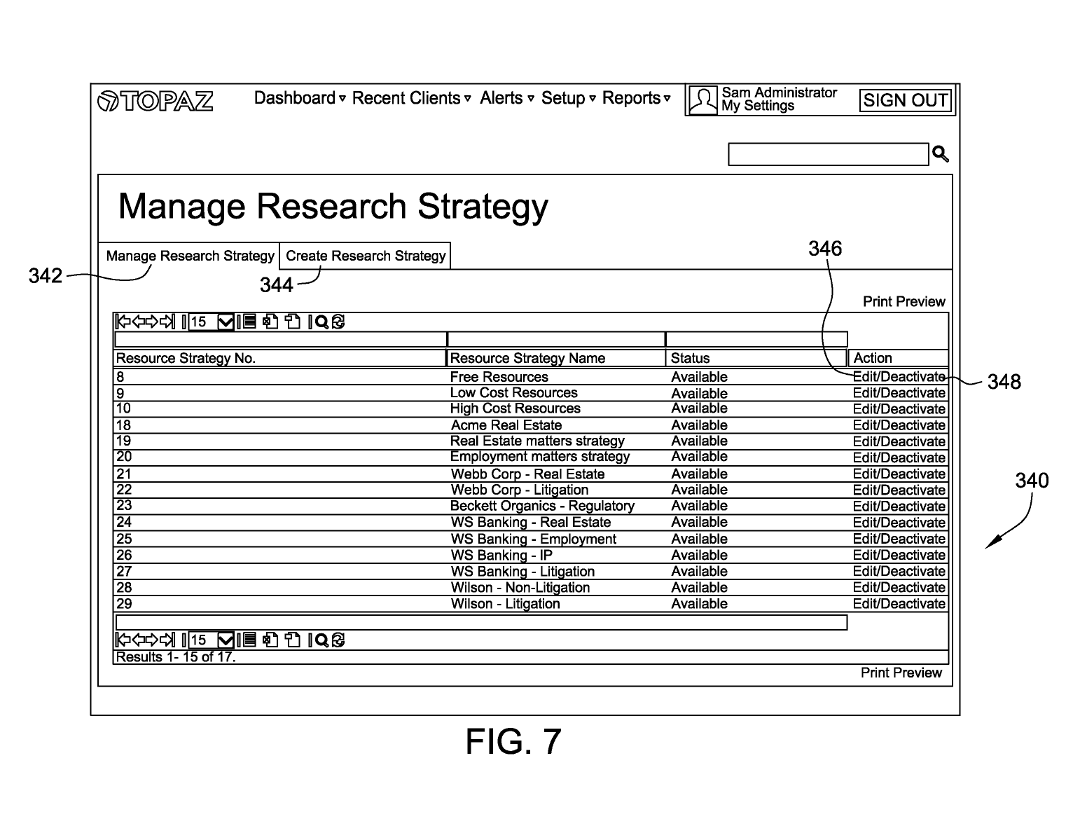

Referring again to FIG. 3, setup menu 304 further includes a research strategy option. When administrator user 112 provides an input to the research strategy option from setup menu 304, research server 202 provides a research strategy interface 340 as illustrated in FIG. 7.

Similar to the above, manage research strategy interface 340 includes two tabs: a manage research strategy tab 342 and a create research strategy tab 344. As shown, manage research strategy tab 342 includes a listing of research strategies, which may be general to one or more clients, specific to client, specific to client matter, specific to a type of legal matter, specific to cost designation or classification, specific to business structures or practices of the entity, etc. As used herein, a research strategy includes a plan of resources and/or a designation of the resource intended to aid a researcher in selecting and/or utilizing one or more resources, potentially specific to a client, a matter, entity structures (such as practice areas of professional service firms or corporate departments) and/or a type of research to be performed. In the exemplary embodiment, the research strategy may guide user 112 on what workflow, methodology, and/or resources to utilize in obtaining specific information for a particular client and/or client matter. It should be appreciated that various types of research strategies may be based on a variety of factors, including, without limitation, one or more preferences of access control, client(s), cost, accessibility, resource contract terms, client approval of one or more resources, alternative billing arrangements for external clients where overhead costs are a significant factor, requirement of external clients to use their internal information subscriptions, environmental considerations of the law firm to reduce printing costs/paper use, etc

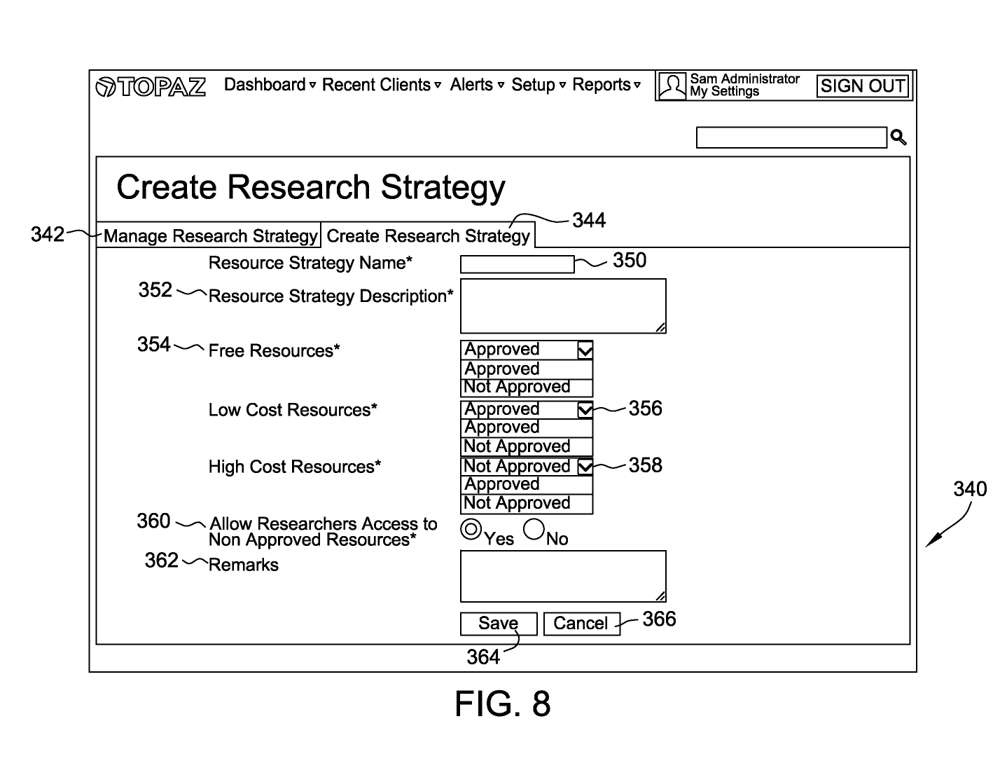

In this exemplary embodiment, create research strategy tab 344 is usable to add a research strategy to the research application, as shown in FIG. 8. A research strategy may be added to the research application by providing some or all of the information requested in create research strategy tab 344 and submitting such information to research server 202. It should be appreciated that various types of information may be solicited by the create research strategy tab 344 in other embodiments. Specifically, for example, as illustrated in FIG. 8, create research strategy tab 344 solicits a research strategy name 350 and a research strategy description 352, which may describe the resource strategy assigned for a specific client/client matter. The research strategy description is provided for presentation to a researcher user 112 when a client and/or a client matter assigned with the research strategy is selected by research user 112. The research strategy description provides a statement of what kind of resources should be utilized, what resources should be avoided, and/or for how long such resources may be accessed. Create research strategy tab 344 further permits the user 112 to designate free, low cost and high cost resources as “approved” or “not approved” at free resource designation 354, a low cost resource designation 356, and a high cost resource designation 358, respectively. Additionally, in this example, selection of allow non-approved resources 360 provides the option of using the respective resource, even when the resource is “not approved” as defined by the research strategy. Further, create research strategy tab 344 includes a remarks section 362 to permit a user 112 to include any remarks, potentially relevant to the use and/or purpose of the research strategy, cite the specific document, person or group within the enterprise authorizing the research strategy or a resource designated by the research strategy.

As shown in FIG. 8, some of the information requested is marked with an asterisk, designating such information as required prior to saving the new research strategy. More, less, other, or no information may be required to save a research strategy in other embodiments. Further, as should be apparent, other types and/or orders of information may be included in other create research strategy tab embodiments, potentially depending on the number of options and/or resources associated with a research strategy. Specifically, for example, create research strategy tab 344 may permit a user to enter and/or selected multiple resources to be used in a specific order for a specific client and/or client matter. Any information potentially helpful to researcher user 112 to perform research consistent with the law firm's and/or a client's criteria may be included in the research strategy. Such information may further include, without limitation, designated resources for printing, research flow and/or step-by-step instructions for researching particular types of information (e.g., legislative history), designation of high-cost function to avoid (e.g., printing through a particular resource), instructions for accessing a client's resource account, etc.

Once information, including the required information (if any), is entered, the user 112 may select the “save” button 364 at workstation 208 to submit the request for the research strategy to research server 202. In turn, research server 202 receives the request from the user to create the research strategy and saves the information included in the request for research strategy in memory device 104. Research server 202 then generates a research strategy entry, which is provided for presentation to workstation 208 in the listing of research strategies in manage research strategy tab 342, as shown in FIG. 8. The research strategies may be assigned to one or more clients, client matters, practice groups, user types, users, etc. Research strategies may be assigned based on, for example, client preferences, cost reduction measures, firm preferred resources, one or more preferences of access control, resource contract terms, client approval of one or more resources, alternative billing arrangements for external clients, environmental considerations of the firm to reduce printing costs/paper use, and/or any other aspect of a resource that might make the resource preferred over another.

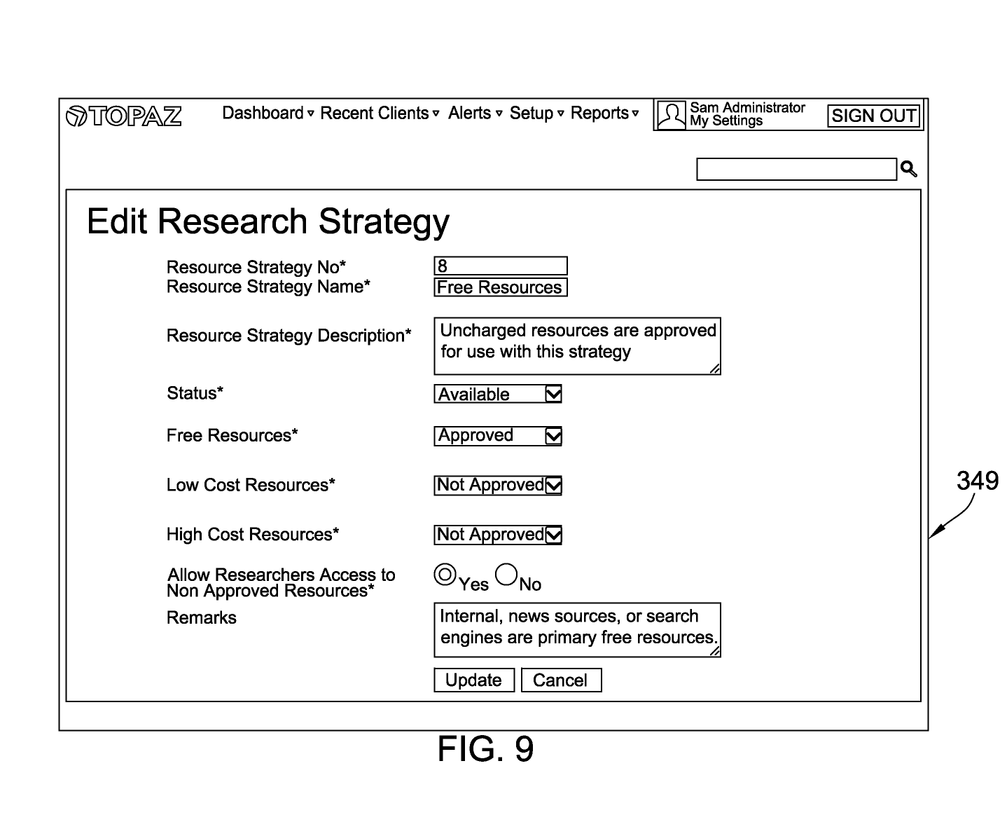

Referring again to FIG. 7, manage research strategy tab 342 may be utilized to receive one or more user inputs to edit and/or deactivate one or more of the resource strategies. Specifically, for example, administrator user 112 may select the “edit” button 346 to edit the research strategy. In response, research server 202 provides an edit research strategy interface 349 (FIG. 9) for presentation to administrator user 112. As shown, edit research strategy interface 349 solicits substantially the same information solicited by create research strategy tab 344. Additionally, or alternatively, administrator user 112 may select the “deactivate” button 348 to deactivate the research strategy, whereby the research strategy would not be assignable to a client matter and/or accessible to a researcher.

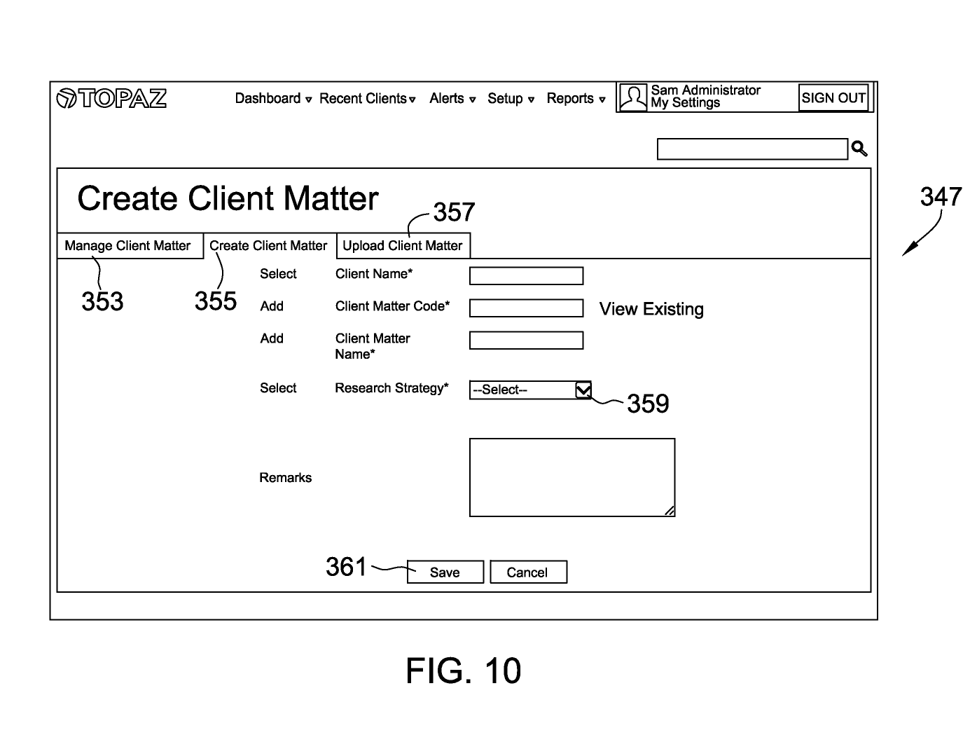

Referring again to FIG. 3, in the exemplary embodiment, setup menu 304 includes setup option related to client matters, clients, researchers, firm administration and system settings. When client matter is selected by administrator user 112, a client matter interface 347 (FIG. 10) is provided by research server 202 for presentation at workstation 208. Client matter interface 347 includes tabs 353, 355, and 357 for managing, creating, and uploading client matters, respectively. As shown, when create client matter tab 355 is elected, administrator user 112 is permitted to provide a request to add a client matter to research server 202. The request includes information, such as client name, client matter code, client matter name, and remarks. Further, create client matter tab 355 includes a pull down menu 359 to select a research strategy for the client matter. As such, administrator user 112 is permitted to select on of the research strategies managed and/or created through research strategy interface 340. Additionally, or alternatively, create client matter tab 355 may include a “create research strategy” button to invoke research strategy interface 340 to permit administrator 112 to create/manage a research strategy for the newly create client matter. After the administrator user has filled in sufficient information, a “save” button 361 may be selected to transmit the request for the client matter to research server 202, which stores the client matter is memory device 104 and appends the client matter to appropriate interfaces for presentation at workstation 208. Similar to create resource tab 310, some of the information for a client matter request is starred indicating the information is required. It should be appreciated that other required and not required information may be included in a request for a new client matter.

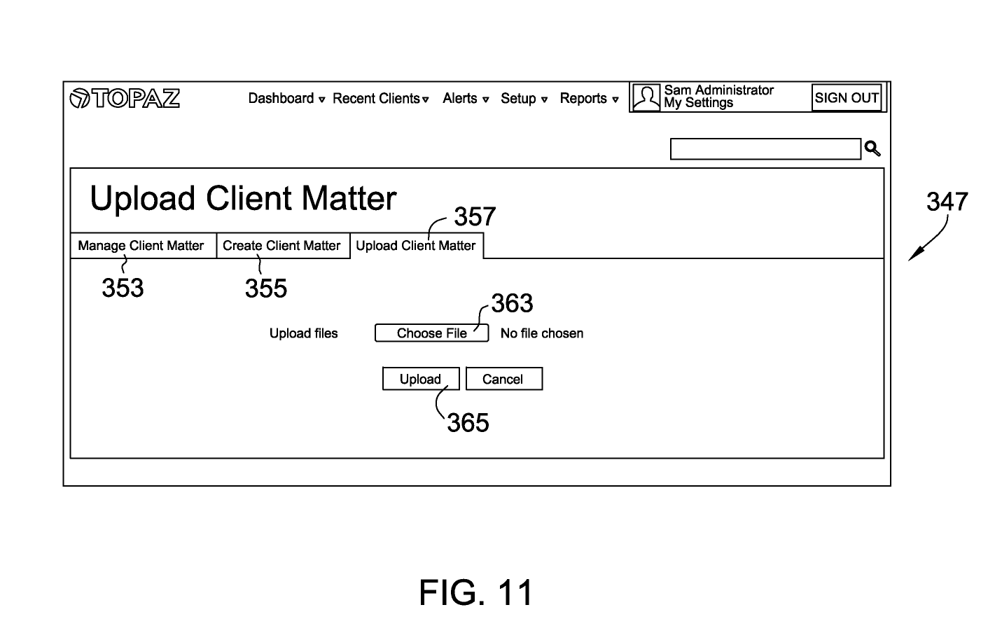

As shown in FIG. 11, when the upload client matter tab 357 is selected, administrator user 112 is permitted to upload a client matter file containing one or more client matters. Often, the client matter file includes substantially the same information included in the create client matter tab 355. The client matter files is searched and/or located through the “Choose File” button 363 and uploaded to research server 202 when an “upload” button 365 is selected. When the client matter files is upload, research server 202 receives the client matter file and creates/stores client matters based on the content of the client matter file. Furthermore, manage client matter tab 353 permits administrator user 112 to edit a previously created client matter.

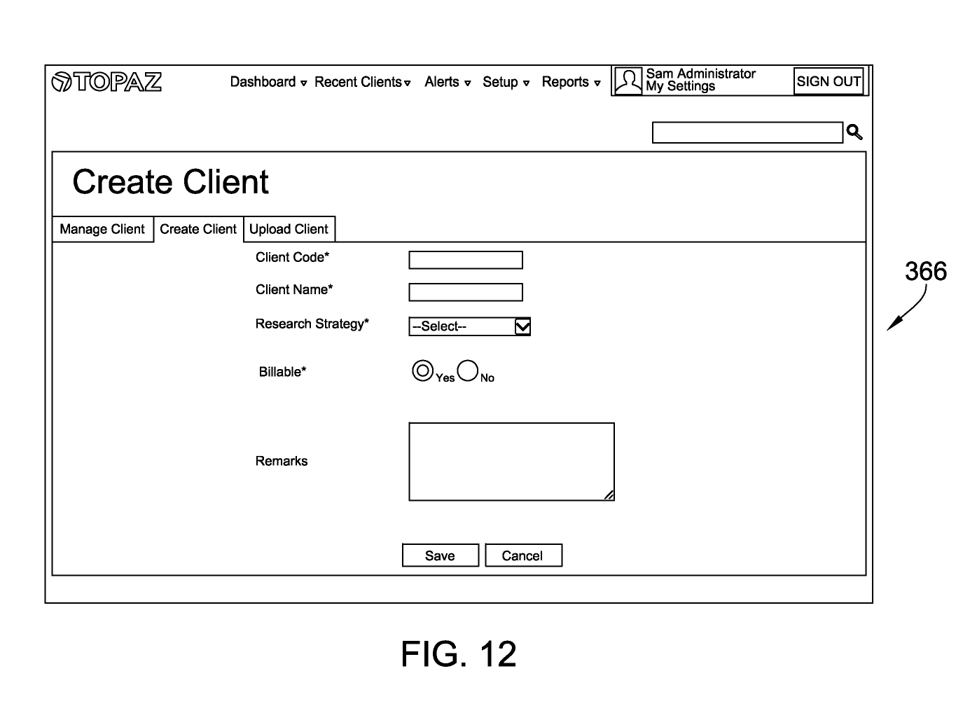

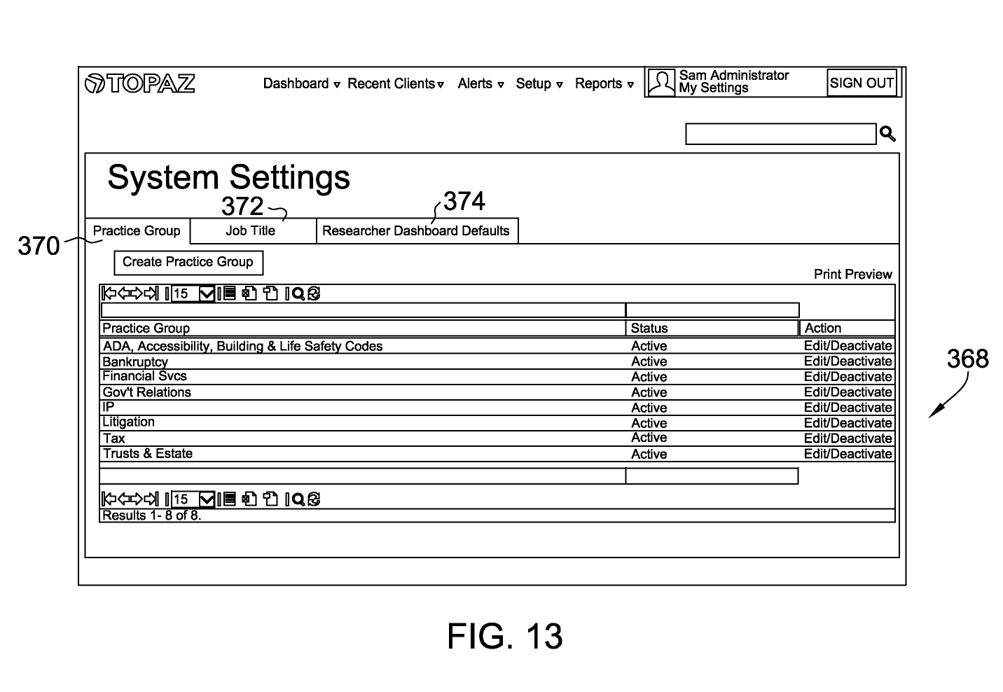

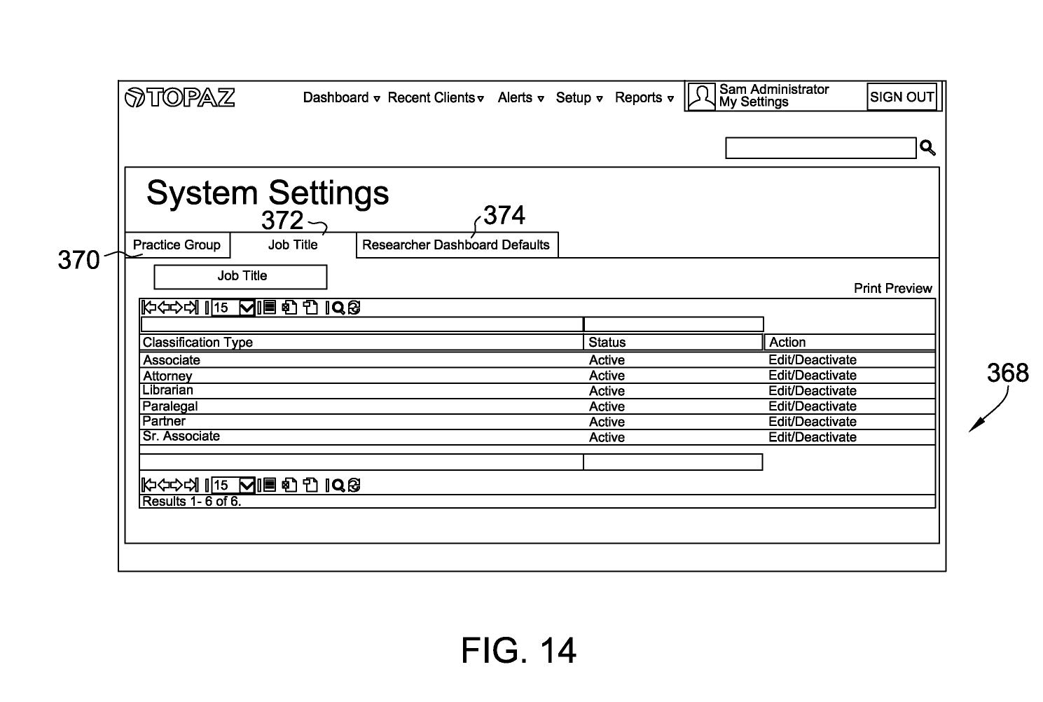

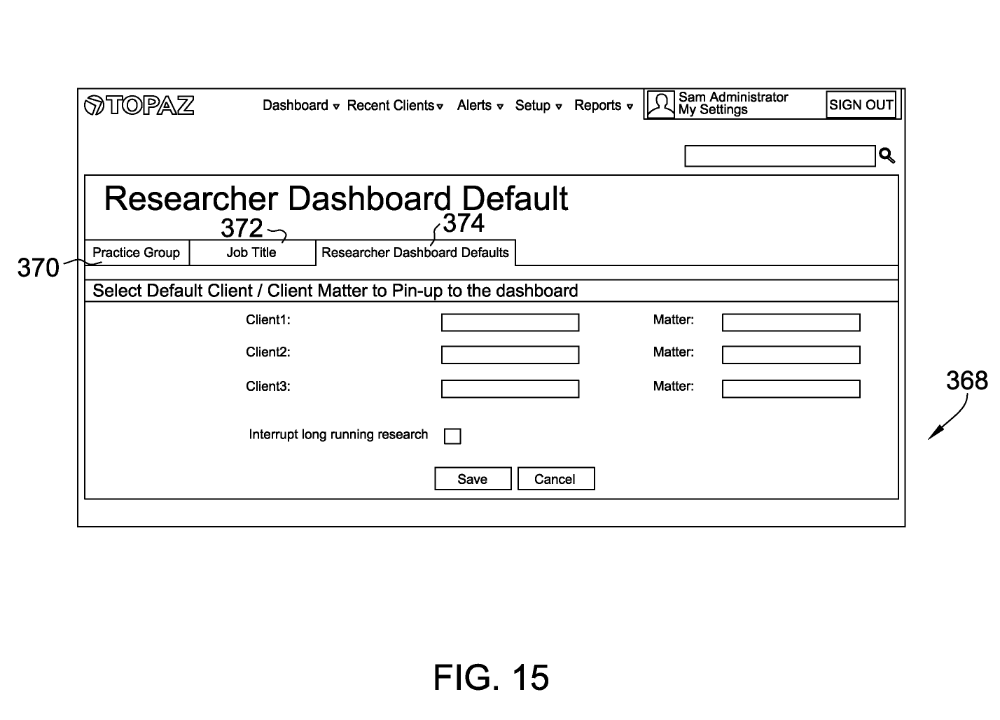

When client is selected from setup menu 304, a client interface 366 is provided from research server 202 for presentation to administrator user 112 at workstation 208. As shown in FIG. 12, client interface 366 includes three tabs for managing creating, and uploading clients. Client interface 366 operates substantially similar to client matter interface 347. When system settings is selected from setup menu 304, a system setting interface 368 is provided from research server 202 for presentation to administrator user 112 at workstation 208. As shown in FIG. 13, system setting interface 368 includes tabs 370, 372, and 374 for practice group, job title, and research dashboard defaults, respectively. Practice group tab 370 permits administrator user 112 to create and/or edit practice groups within the law firm. Further, as shown in FIG. 14, job title tab 372 permits administrator user 112 to create and/or edit classification of users 112 of the research application. As shown in FIG. 15, researcher dashboard default tab 374 permits administrator user 112 to select clients and matters to be included in a researcher dashboard, assigned to a particular researcher, a practice group, another other division of users of the research application. More specifically, researcher dashboard default tab 374 permits administrator user 112 to include three clients and matters on the researcher dashboard and to check the box to interrupt long running research. It should be appreciated that a different number of clients and/or client matters may be included in other system setting interface embodiments. In some embodiments, administrator user 112 may be able to selected one or more most recently accessed clients and/or matters are included in a researcher dashboard. In at least one embodiment, a researcher dashboard may include a combination of assigned and most recently accessed clients and/ort matters.

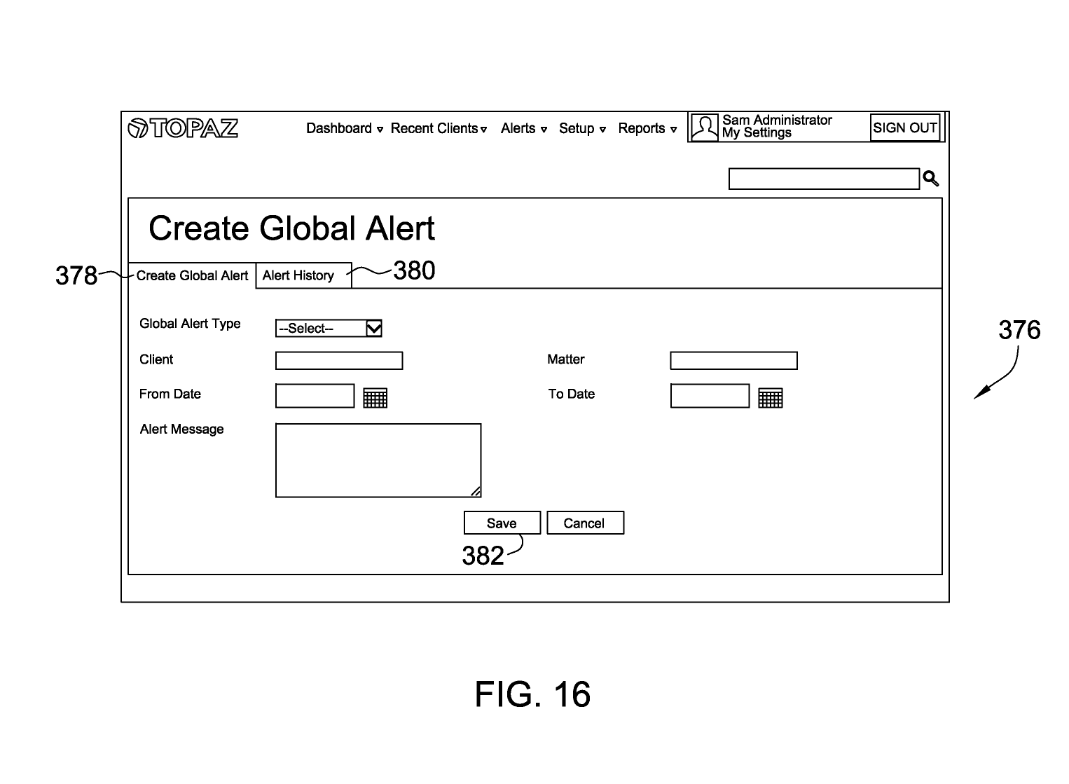

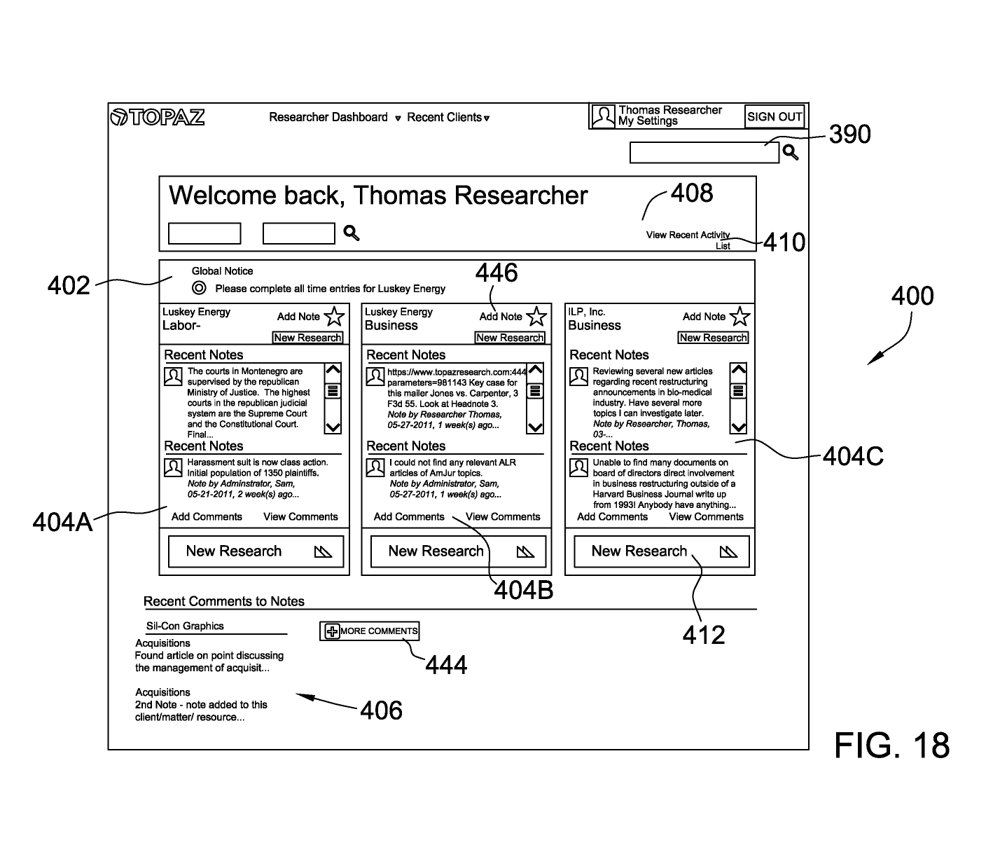

In addition to setup menu 304, dashboard interface 300 provides options to administrator user 112 to setup alerts by providing an input at workstation 208 to the alerts button 337 of dashboard interface 300. From alerts button 337, administrator user 112 is able to select one or more types of alerts, including, without limitation, global alerts, client alerts, researcher alerts, etc. FIG. 16 illustrates an exemplary global alert interface 376, which is provided from research server 202 for presentation to administrator user 112 at workstation 208. Global alert interface 376 includes a create global alerts tab 378 and an alert history tab 380. As shown, when create global alerts tab 378 is selected, administrator user 112 is permitted to create a global alert request by providing information, such as global alert type, client, client matter, time/date information, and the alert message. When administrator user 112 provides an input to the “save” button 382 of create global alerts tab 378, workstation 208 transmits the global alert request to research server 202, which saves the global alert request in memory device 104. Additionally, research server 202 publishes the global alert according to the information provided. For example, research server 202 publishes a global alert for a particular client matter to one or more users 112 of the research application, who access the client matter. More generally, global alerts may be directed to each user 112 firm-wide, each user 112 associated with a client, and/or each user 112 associated with a client matter. The presentation of the global alert is described in further detail below with reference to FIG. 18. It should be appreciated that different information may be solicited by research server 202, in order to complete global alert request, in other research application embodiments.

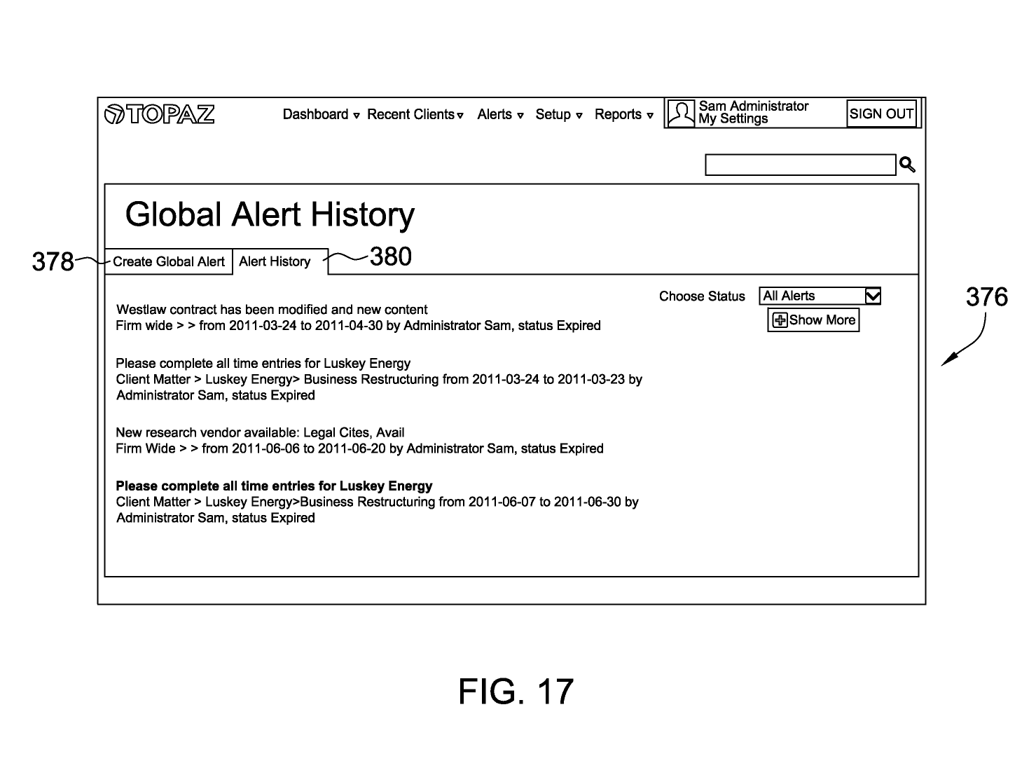

Further, as shown in FIG. 17, alert history tab 380 is selected to provide information about prior global alerts submitted by one or more administrator users 112 from workstation 208 to research server 202.

Referring again to FIG. 3, in the exemplary embodiment, dashboard interface 300 provides multiple types of information for presentation to administrator user 112. Specifically, as shown, dashboard interface 300 includes recent activities panel 384, which lists recent activities completed on the research application. Recent activities may be filtered, by resource, client, client matter, practice group, researcher, administrator, duration, etc. Dashboard interface 300 further includes an alert panel 386, which indicates one or more alerts to administrator user 112. In this particular embodiment, an alert indicating a non-approved resource use is displayed to the administrator, when the administrator accesses the research application. In this manner, an administrator accessing dashboard interface 300 is substantially immediately presented with useful alerts in alert panel 386 pertaining to the research application. In various embodiments, alerts may be selected, filtered and/or restricted based on one or more user preferences, to reduce the occurrence of lower priority alerts, while preserving higher priority alerts. As such, dashboard interface 300 provides the administrator with a centralized location for creating and/or viewing alerts pertaining to multiple resources.

Furthermore, dashboard interface 300 includes usage panel 388, which indicates information related to the usage of one or more resources of the research application. Resources usage may be presented based on resource, time, researcher, client, client matter, practice group, classification/job title, etc. Further, in the exemplary embodiment, dashboard interface 300 includes a search box 390, which may be utilized by administrator user 112 to search within the research application for a client, client matter, note, comment, or other type of information contained with the research application. As shown herein, the search box is included in several interfaces provided by research server 202 for presentation to administrator user 112 and/or researcher user 112.

FIG. 18 illustrates a dashboard interface 400 according to another exemplary embodiment. In this exemplary embodiment, dashboard interface 400 is provided by research server 202 for presentation to user 112 at workstation 208, when a researcher accesses the research application. As shown, dashboard interface 400 includes a search box 390, a global notice panel 402, three matters 404, and comments panel 406.

In this exemplary embodiment, global notice panel 402 provides global alerts created by an administrator or another user 112 according the description above. In this manner, researcher user 112 is presented with global alerts upon accessing dashboard interface 400. As a result, the researcher is often efficiently made aware of changes, warnings, and/or messages from an administrator or other user, just prior to initiating one or more research sessions. As compared to known methods, in which administrators must either disseminate paper alerts, provide telephonic or in-person alerts to researchers, or email alerts to researchers, dashboard interface 400 provides a convenient display of the alerts linked to the client page, client matter page or actual research session. More specifically, the alerts are provided from research server 202 for presentation to the user 112 as part of the research application, rather than, for example, placing an alert in the researcher inbox or displaying alerts is a separate email program, such as Outlook® or personal contact via telephone or in-person meeting.

In this exemplary embodiment, matters 404 include the most recently utilized matters. Alternatively, as described with reference to FIG. 15, administrator user 112 may select default client and/or client matters for one or more researcher users 112. In other embodiments, the researcher may select matters 404 to be included in dashboard interface 400. In another example, a research may select two matters 404A and 404B, which are frequently accesses to stay static in dashboard interface 400, while permitting matter 404C to be dynamically changed to include the most recently accessed matter (other than 404A and 404B). It should be appreciated that a different number of matters 404 may be included in dashboard interface 400, potentially depending on the amount of information displayed in dashboard interface 400. Multiple interfaces are available to view varying number of client matter depending on the preferences of the researcher. An example is a matrix view presenting fifteen client and/or client matters. In this exemplary embodiment, each of matters 404 includes recently added notes, such that the researcher at dashboard interface 400 may be able to understand the last task completed and/or initiated for matter 404 along with research workflow and process notes in order to maintain an archive of their work for a particular client and/or client matter, while potentially preserving workflow efficiencies. In addition, notes may provide a knowledge management repository for the research or other data, which may be retrieved for the benefit of the client or another client of the law firm. In other embodiments, other information may be included in the dashboard interface 400 for some or all matters 404. For example, matter 404 may includes client name, client matter name, client number, client matter number, and/or a listing of attorneys associated with and/or responsible for matter 404.

Each of matters 404 may include a generic client matter, such that all research for that client is performed under than matter. Alternatively, matter 404 may be specific to a type of research, a litigation matter, a transactional matter, by business unit or department, or any other sub-division of a research project. In this exemplary embodiment, researcher user 112 may further search for a client and matter in the search field 408. Further, the “view recent activity list” button 410 is provided to display a specified number of recently accessed matters, including, for example, the 15, 50, or 100 most recently accessed matters. The number of matters may be selected by a researcher, an administrator, or other user.

When researcher user 112 accesses the research application to perform research, researcher user 112 identifies a matter within matters 404, from the most recently accesses matters, or through a search, and selected the “new research” button 412. Selection of the “new research” button 412 is transmitted from workstation 208 to research server 202, which, in turn, provides a select resource interface 414 for presentation to researcher user 112 at workstation 208, as shown in FIG. 19. Select resource interface 414 includes a research strategy 422 assigned to the selected matter, by the researcher, the administrator or other user.

In this exemplary embodiment, select resource interface 414 includes a pull-down menu 416 to select one or multiple resources. More specifically, when the pull-down is selected by researcher user 112, research server 202 provides a listing of resource entries for presentation to researcher user 112. It should be appreciated that in other embodiments, resources may be presented in select resource interface 414 in various manners, including a listing of all resources (by resource name or cost type). Researcher user 112, in turn, selects one of the resource entries to perform research utilizing that resource. When the resource is selected by the user 112, select resource interface 414 includes various types of information about the resource, including a resource designator, a resource description 418, and tips 420 for utilizing the resource. A designator may be any information provided by administrative user 112 to differentiate one resource from another. In this example embodiment, a cost designator 424 is provided from research server 202 for presentation to researcher user 112. In this manner, the research strategy 422 of the matter may be compared to the cost designation 424 if the resource, to determine is the resources is acceptable for the matter. Accordingly, the researcher is given specific criteria via the client research strategy 422, when initiating research, to select one or more resources for performing research.

If the resource is consistent with research strategy 422, the researcher 112 may proceed to provide an input to an “access” button 426. In various embodiments, the researcher may disregard research strategy 422 and proceed to access a non-approved resource. In such an embodiment, if research strategy 422 permits access non-approved resources 360 of FIG. 8, researcher user 112 will be permitted to access the resource. In at least one embodiments, when researcher user 112 attempts to access a non-approved resource, a warning and/or alert may be presented to researcher user 112 to inform him/her of the non-approved resources, which may be bypassed to continue to access the resource. Alternatively, a warning and/or alert may be present to researcher user 112, which cannot be bypassed, when the researcher user 112 has not been granted permission by research strategy 422 to access non-approved resources 360.

In at least one embodiment, credentials for accessing the resource may also be included in select resource interface 414, such that when the resource is launched within research connector 210, the credentials are readily available to researcher user 112. Alternatively, in another embodiment, credentials for a resource may be automatically filled and/or submitted by research server 202. More specifically, some resource websites may programmatically received credentials, with various Meta fields to be added to the resource using HTTP POST/GET methods when administrator user 112 creates the resource entry (as shown in FIG. 5). In the exemplary embodiment, research connector 210 may include additional infrastructure to make JavaScript calls dynamically along with the credentials to resources. For such resources, research connector 210 may automatically identify a JavaScript being called and set it up as Meta data at the time of resource itself setup. Is should be appreciated that other functionality and/or infrastructure may be included in research connector 210 and/or provided from research server 202 to automatically or manually provide efficient presentation of credentials to a resource.

When the input to “access” button is received by research server 202, research server 202 transmits a research session initiation command to workstation 208, in order to launch a web browser 428 within research connector 210 as shown in FIG. 20. As described above, research connector 210 is an application within workstation 208, which is initiated by the research server 202 in response to an input from researcher user 112 to access a resource. Research connector 210 interacts with web browser 428 to access the resource and provide various functions related to the resource. Specifically, as shown in FIG. 20, research connector 210 includes navigation buttons 430 and 432 to navigate forward and backward within web browser 428. Research connector 210 includes a print button 434. In the exemplary embodiment, selecting print button 434 prints the web page in view within research connector 210. In one alternative embodiment, when a researcher selects print button 434, another instance of the document currently being viewed within research connector 210 may be printed. For example, it may cost a fee to print the document directly from the resource, but another instance of the document may also be available to print without charge at another resource. Accordingly, to facilitate reducing costs associated with printing, selecting print button 434 prints a free or relatively inexpensive instance of the document, if available. Additionally, or alternatively, print button 434 may be usable to invoke the print method described below. Research connector 210 further includes a switch button 436 to change the client and/or matter the research session will be assigned to and track for. Research connector 210 also provides a rating system of the resource accessed for the specific client and/or client matter through other buttons including a green “thumbs up” icon meaning the researcher approves of or likes the resource and a red “thumbs down” icon meaning the researcher disapproves of or dislikes the resource, providing feedback to the procurement process. In the exemplary embodiment, as shown in FIG. 20, research connector 210 includes the rating icons. Alternatively, the rating icons may be displayed when the researcher logs off of research connector 210.

If desired, a dialog box may appear to solicit specific feedback or provide a short survey to elicit additional information. Administrator user 112 may automatically receive this rating and/or feedback information through research server 202.

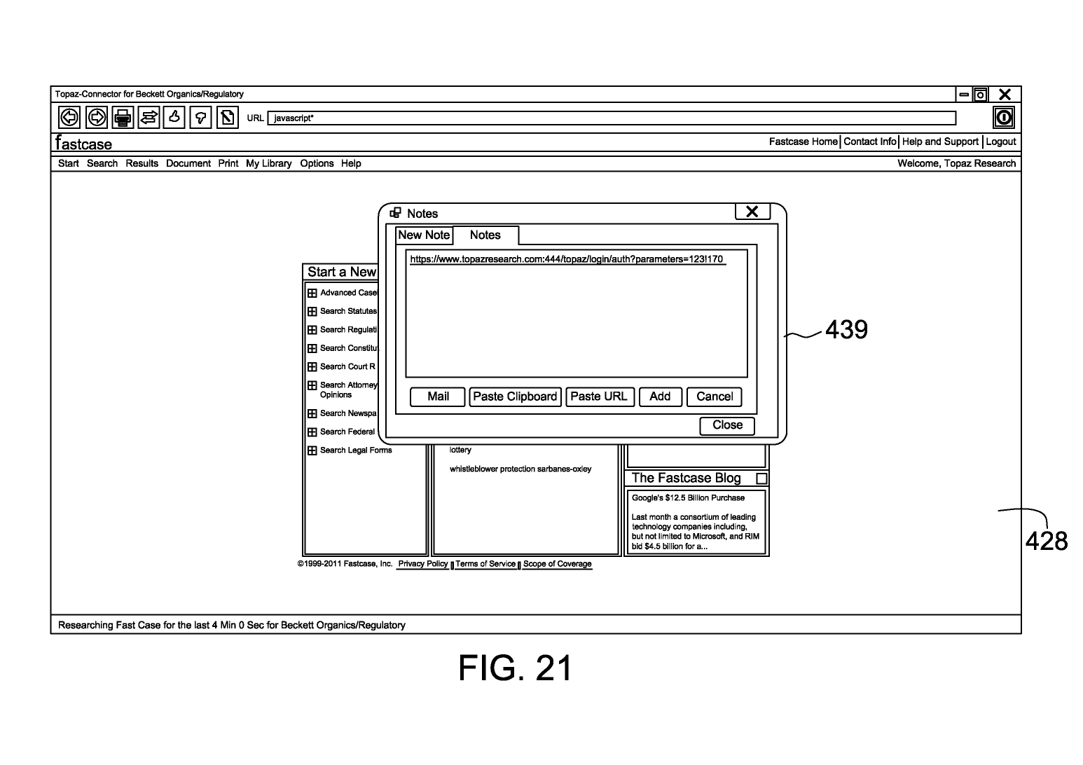

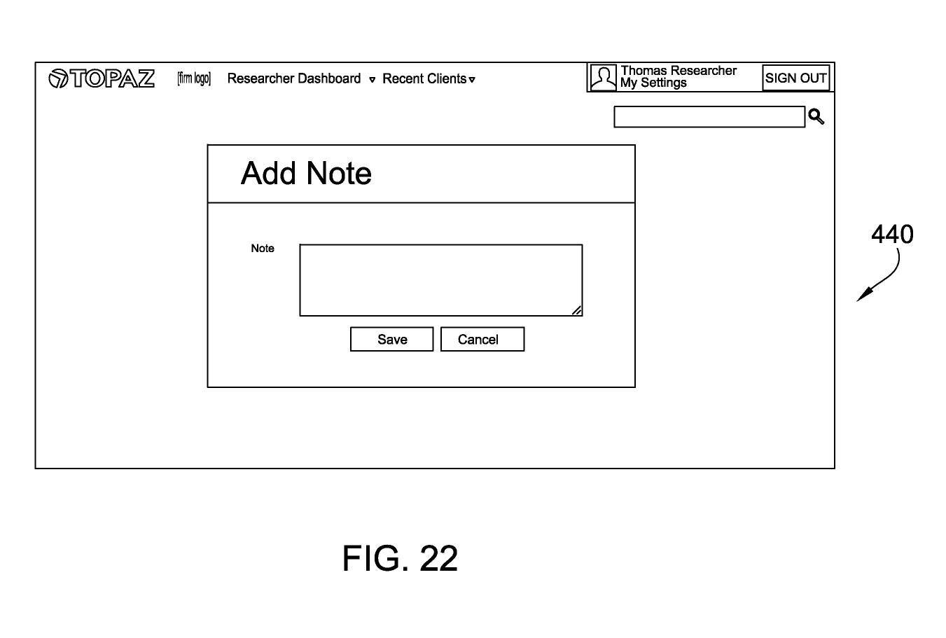

Moreover, research connector 210 includes an add notes button 438, which may be selected by researcher user 112 to add a note to the client and/or matter from which the research session has been launched (and/or changed to via change button 436). In response to the selection of add note button, an add note interface 439 is provided from research server 202 for presentation to the researcher 112, as shown in FIG. 21. Researcher user 112 is permitted to add a note to the client or client matter (as shown in FIG. 18). Notes may include a section of a resource, citations to important documents, entered notation from research user, a webpage, a status, or any other information that may be pertinent to the client and client matter. When a note is added to a client and/or client matter, the note is appended to matters 404 which may be viewed in other researcher users' 112 dashboard interface 400. Notes provide a knowledge management function, such that multiple researchers are able to work on one or more matters, while sharing thoughts and/or information about the research. As such, notes provide knowledge sharing amongst multiple researchers and/or records of previously performed research. Furthermore, the notes are maintained and/or presented with by research server 202, and therefore the notes are tied to the matter and the research application, through which further research is performed. More specifically, when submitted, the notes are stored in memory device 104 of research server 202 and provided for presentation to researcher user 112 at workstation 208. In this manner, research server 202 and/or the research application provides a centralized application to coordinate and share research progress on a particular client and/or client matter, thereby providing improved efficiency, collaboration, and/or organization in researching at least one topic over known resources. FIG. 22 illustrates an add note interface 440, which is provided from presentation to researcher user 112 by selected “add note” button 446 from dashboard interface 400, rather than research connector 210 shown in FIG. 20.

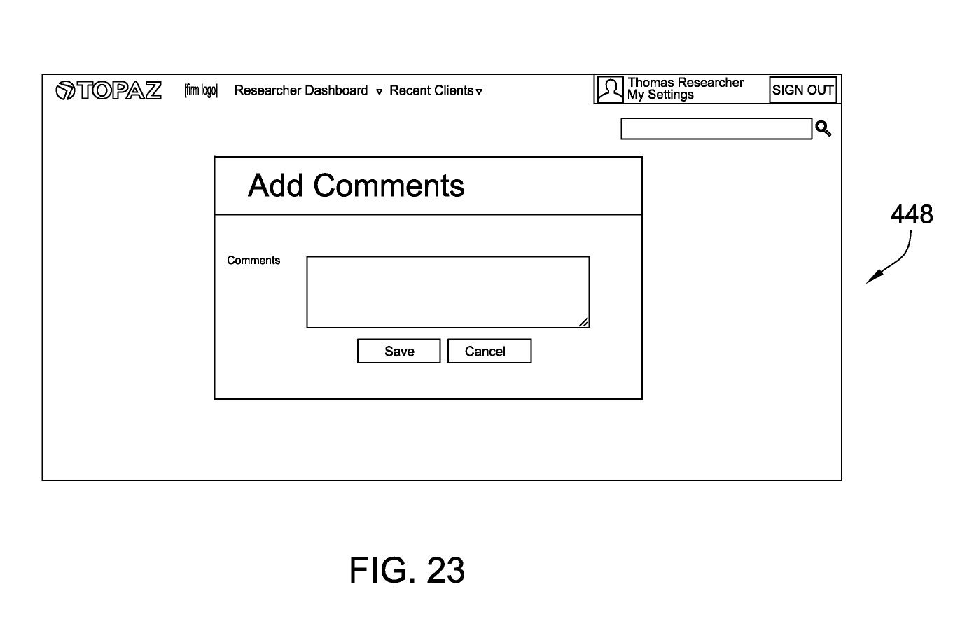

To further facilitate research sharing within the research application, research users and/or other users are permitted to add comments to notes posted to clients and/or client matters. Specifically, when researcher user 112 selects a “add comment” button 444, as shown in FIG. 23, add comment interface 448 is provided from research server 202 for presentation to research user at workstation 208. Add comment interface 448 permits researcher user 112 to submit comments to another research user's notes. The comments are appended to comments panel 406. As such, research dashboard provides communication among researchers to provide collaboration so that researcher users 112 do not duplicate work and/or effort related to one or more resources and/or documents identified from the resources. Furthermore, notes and comments permit research users 112 to see who else is assigned to a client and/or client matter and give such users 112 the opportunity to collaborate without geographic or other boundaries. By creation of notes and/or comments, resources, workflow, hints, and/or helpful tactics for specific types of or topic areas of research may provide collaboration and mentoring of less experienced research users 112, by more experienced researcher users 112. Notes and/or comments further permits sharing of who has performed a specific kind of research, even for specific clients, and then seek out advice from that researcher user 112. In various embodiments, as law firms attempt to reorganize along the lines of specific industries as opposed to practice groups, the research application may provide invaluable collaboration amongst researcher users 112 and virtual team building as groups of users with varied skill sets and practice experiences interact through the research application.

Referring again to FIG. 20, in the exemplary embodiment, research connector 210 includes a logoff button 442. In some embodiments, research connector 210 also includes a report issue button (not shown) that permits the user 112 to send a message to research server 202, regarding an issue with accessing one or more resource, a resource feature, and/or the presentation of the resource within research connector 210. In this manner, an administrator of the research application is able to track and/or respond to issues as provided by the researcher 112 or other user. The logoff button 442 terminates the research session and closes research connector 210. As a result, a time keeper 445 terminates and the time is reported to research server 202, which is stored in memory device 104. In this exemplary embodiment, time keeper 445 tracks the amount of time a researcher spent researching the matter, once the research session has been initiated.

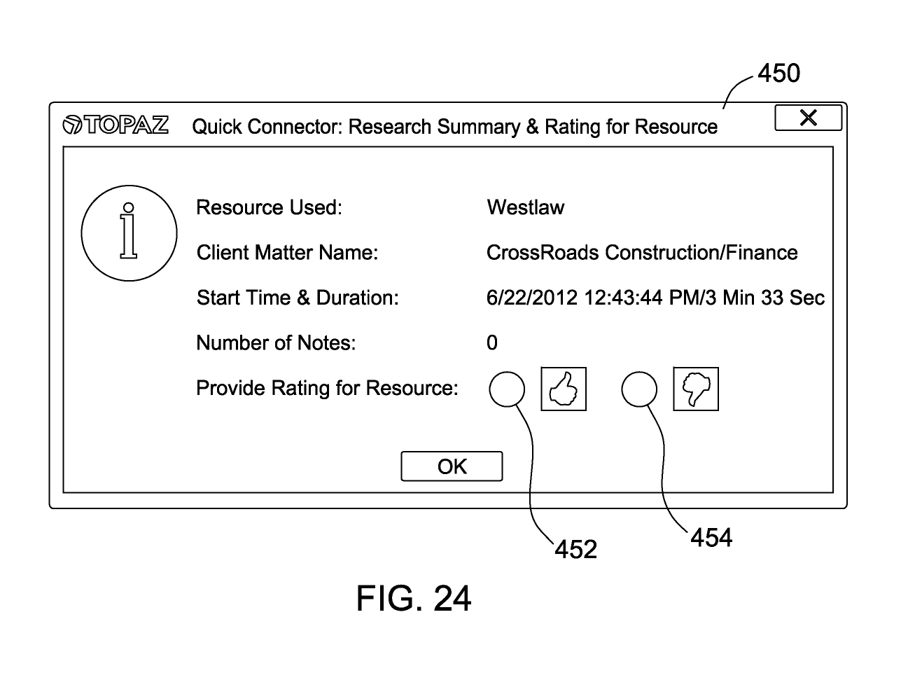

As shown in FIG. 24, in one embodiment, when the logoff button 442 is selected, a rating window 450 including an approval button 452 adjacent a green “thumbs up” icon and a disapproval button 454 adjacent a red “thumbs down” icon, To provide feedback, if the researcher approves of or likes the resource, the researcher can select the approval button, and if the researcher disapproves of or dislikes the resource, the researcher can select the disapproval button.

When the research session is complete, researcher user 112 is returned to dashboard interface 400 to select one or more other resources, clients and/or client matters for further research. While a number of processes and/or methods are described specifically with reference to administrator user 112 or researcher user 112, it should be appreciated that such functions and/or methods may be performed by administrator users, researcher users and/or other users. Further, such functions and/or methods may be accessible to administrator users, researcher users, and/or other users through one or more different dashboard interfaces.

According to the present disclosure, the research application may provide several print operation options to user 112 through the research application print menu. The research application allows a research user 112 the optional ability to have document citations highlighted within a document being viewed through research connector 210. Specifically, when researcher user 112 identifies a citation to be printed, the researcher 122 may “right-click” on the highlighted citation and/or manual highlight the citation to display the research application print menu. From the research application print menu, researcher user 112 is able to selected one of several print commands, including save citation to queue (for later printing, saving and/or reference), print document from an attached and/or network printer, save document to a local or network memory device 104, and/or send documents, via email, SMS message, or another electronic form. In the exemplary embodiment, research server 202 and/or research connector 210 may visually distinguish the citation, once the citation has be subject to a print command, so that research user 112 or another researcher user 112 does not re-print, re-save, and/or re-send a document previously printed, saved, and/or sent. In the exemplary embodiment, a citation is generally highlighted in a different color, as compared to other citations in the resource. In at least one embodiment, a print button may be selected by the researcher 112 from research connector 210 to display the print menu.

Exemplary computer readable media may include, without limitation, hard disk storage, optical drive/disk storage, removable disk storage, flash memory, non-volatile memory, ROM, EEPROM, random access memory (RAM), etc. By way of example and not limitation, computer readable media may comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system, the methods and/or processes described herein may be employed with numerous other general purpose or special purpose computing system or configurations. Examples of computing systems include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, web servers, minicomputers, mainframe computers, distributed computing environments that include any of the above systems or devices, and the like.

Embodiments of the present disclosure may be described in the general context of computer-executable instructions, such as program modules, executed by one or more computers or other devices. The computer-executable instructions may be organized into one or more computer-executable components or medias. Generally, program instructions include, but are not limited to, routines, programs, objects, components, and data structures that perform particular tasks or implement particular abstract data types. Aspects of the present disclosure may be implemented with any number and organization of such components or medias. For example, aspects of the present disclosure are not limited to the specific computer-executable instructions or the specific components or medias illustrated in the figures and described herein. Other embodiments may include different computer-executable instructions or components having more or less functionality than illustrated and described herein.

One or more aspects of the present disclosure transform a general-purpose computing device into a special-purpose computing device when configured to execute the instructions described herein.

Moreover, the order of execution or performance of the operations in embodiments illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of the present disclosure as defined in the appended claims. As various changes could be made in the above constructions, products, and methods without departing from the scope of the present disclosure, it is intended that all matter contained in the above description and shown in the accompanying drawings shall be interpreted as illustrative and not in a limiting sense.

What is claimed is:

1. A computer-based method for use in researching at least one topic using a computing device coupled to a memory device, said method comprising:
receiving, at the computing device, from a user a selection of at least one of a client and a client matter;
querying the memory device to determine a research strategy associated with the at least one of a client and a client matter in response to the selection; and
providing, at the computing device, for presentation to the user the research strategy associated with the at least one of a client and a client matter, wherein the research strategy includes at least one resource and at least one resource designator associated with the at least one resource.

2. The method of claim 1, wherein the at least one resource designator is associated with the at least one resource and indicates a cost associated with the at least one resource.

3. The method of claim 1, wherein the at least one resource designator includes a graphical indicator of a cost associated with the at least one resource.

4. The method of claim 1, further comprising receiving, at the computing device, a resource access command for the at least one resource; and
transmitting a research session initiation command to a user workstation to launch a research connector including a web browser directed to the at least one resource.

5. The method of claim 1, wherein providing for presentation to the user the research strategy includes providing a dashboard interface for presentation to the user, wherein the dashboard interface includes a recently-accessed research matter and a global alert panel.

6. The method of claim 5, wherein the recently-accessed research matter includes a plurality of notes submitted by at least one user.

7. The method of claim 1, wherein the research strategy includes a description of the at least one resource and a permission for non-approved resources.

8. The method of claim 1, wherein providing for presentation to the user the research strategy includes providing a dashboard interface for presentation to the user, wherein the dashboard interface includes at least one of a description of the at least one resource and at least one note related to the at least one resource.

9. The method of claim 1, further comprising:
receiving, at the computing device, at least one note submitted by a researcher and associated with a research matter;
storing the at least one note in the computing device; and
providing for presentation to the user the at least one note, when the research matter is accessed by the user.

10. A computer-based method for use in researching at least one topic, said method comprising:
receiving, at a computing device, a request to add a resource, the request including a web address for the resource;
automatically generating, at the computing device, a resource entry for the resource, the resource entry configured to launch a web browser directed to the web address within a resource connector, when the resource entry is selected by a user; and
providing a user interface including the resource entry for presentation to the user.

11. The method of claim 10, wherein the request includes a resource identification and a cost designator for the resource.

12. The method of claim 10, wherein the request includes contract information related to the resource.

13. The method of claim 10, further comprising receiving, at the computing device, at least one resource credential; and
appending the at least one resource credential to the resource entry, such that when the resource entry is selected by the user, the at least one resource credential is provided to the web browser directed to the web address.

14. The method of claim 10, wherein the request includes a resource timeout limit.

15. The method of claim 10, further comprising assigning the resource entry to at least one client matter, such that when the user accesses the client matter, the resource is accessible to the user.

16. A computing device for use in researching at least one topic, said computing device comprising:
an input device configured to receive from a user a selection of at least one of a client and a client matter;
a processing device coupled to said input device and configured to determine a research strategy associated with the at least one of a client and a client matter in response to the selection; and
a display device coupled to said input device and configured to present to the user the research strategy associated with the at least one of a client and a client matter, wherein the research strategy includes at least one resource and at least one resource designator associated with the at least one resource.

17. The computing device of claim 16, wherein the at least one resource designator indicates a cost associated with the resource.

18. The computing device of claim 16, wherein to present the research strategy, said display device is configured to display a dashboard interface that includes a recently-accessed research matter and a global alert panel.

19. The computing device of claim 16, wherein said input device is further configured to receive at least one note submitted by a researcher and associated with a research matter.

20. The computing device of claim 19, wherein said display device is further configured to display the at least one note when the associated research matter is accessed by the user.
